(19) United States
(12) Patent Application Publication
(10) Pub. No.: US 2008/0162090 A1
(43) Pub. Date: Jul. 3, 2008

(54) SYSTEM, METHODS, AND COMPUTER READABLE MEDIA, FOR PRODUCT DESIGN USING T-SPLINE DEFORMATION

(76) Inventors: Ernest Clay Perry, Provo, UT (US); Mark D. Landon, Idaho Falls, ID (US); Larry Kellogg, Saratoga Springs, UT (US)

Correspondence Address: TRASK BRITT, P.O. BOX 2550, SALT LAKE CITY, UT, 84110, US

(21) Appl. No.: 11/965,352

(22) Filed: Dec. 27, 2007

Related U.S. Application Data
(60) Provisional application No. 60/877,417, filed on Dec. 27, 2006.

(51) Int. Cl. G06F 17/50; G06F 17/10

(52) U.S. Cl. 703/1; 703/2

(57) ABSTRACT

Methods, systems, and computer readable media are disclosed for analyzing a simulation model. The method includes defining the simulation model utilizing a Computer-Aided Engineering (CAE) tool. A parametric volume including mesh elements at least partially bounding a design object of the simulation model is formed. The parametric volume includes at least one T-spline control point. The method also includes adjusting at least one control point on the parametric volume to deform a portion of the simulation model correlated to the control point. The deformed simulation model is simulated to develop a simulation result. The control point adjusting and the simulating may be repeated.

### CROSS-REFERENCE TO RELATED APPLICATIONS

This application claims the benefit of U.S. Provisional Patent Application Ser. No. 60/877,417 filed Dec. 27, 2006 for SYSTEM AND METHOD, FOR PRODUCT DESIGN USING DIGITAL SIMULATION BASED UPON DEFORMATION OF THE SIMULATION MODEL USING T-SPLINE BASED DEFORMATION, the disclosure of which is incorporated by reference herein in its entirety.

### TECHNICAL FIELD

Embodiments of the present invention relate generally to methods for analyzing and designing products, and more specifically for analyzing and adjusting simulation models of product designs.

### BACKGROUND

Today, engineers often model designs using Computer-Aided Design (CAD) tools and simulations to develop product without having to actually build the product until the engineers have thoroughly analyzed the design. FIG. 1 illustrates a conventional product design process 10.

As part of the design process, a CAD model is created 12. When a design model is ready to analyze, a digital simulation model (also known as a Computer Aided Engineering (CAE) model) such as Finite Element Analysis (FEA) or Computational Fluid Dynamics (CFD) may be created 14. The CAE model is simulated 16 (i.e., solved) to predict certain behaviors or performance aspects of the design. The performance of the design may be assessed 20 based on the simulation of the CAE model. Decision block 22 indicates whether the design is acceptable based on the assessment of the simulation results. If the design is acceptable, the design process may terminate. If, however, the design needs more refinement, design parameters are modified 24 and the design process begins again by creating a new or modified CAD model. This process of designing, modeling, creating analysis models and assessing the analysis results may be repeated many times until the desired performance of the design is achieved.

One difficult portion of this process is the conversion of the design or CAD model into a CAE model or a “mesh.” CAD and CAE models are fundamentally based on entirely different geometric models. CAD models include precise surface representations of the boundaries of the design model. CAE models are created from polygonal building blocks, such as triangles, squares, tetrahedrons, and hexahedrons in three dimensions. Creation of a CAE model or mesh from a CAD model is often a laborious, hands-on process. As a result, currently it may often take hours or days to create an accurate CAE model. Additionally, for each design change, no matter how small, the CAE model has to be completely recreated.

Another less obvious problem with the process is that the ability to modify the CAE model is restricted by the parameters associated with the CAD model. As the engineer comes to better understand the weaknesses of his original design, he may want to change the shape of the model in a way that the original CAD model will not allow.

Free-Form Deformation (FFD) has become an important tool in computer graphics for deforming and changing the shape of objects for character animation and other visual effects in computer graphics. In FFD, the computer graphics object is embedded in a parametric space. FIG. 2 illustrates a computer graphics shape 50 in a parametric space 60. Points on the object are embedded by calculating their parametric coordinates inside that parametric space. The shape of the parametric space may then be changed, as illustrated in FIG. 2. As the parametric shape 60′ is changed, the mapping from parametric space to Cartesian space is changed so that the computer graphics object 50′ is deformed in a corresponding relationship with the parametric space. An FFD is characterized by a grid of control points that define the parametric space. Using FFD may be considered analogous to a sculptor molding clay. As the control points are pushed and pulled in different directions, the model is deformed in a manner similar to how a sculptor molds a clay model by pushing and pulling on points of the surface of the clay model.

A description of FFD is found in Sederberg, T. W. and Parry, S R., “Free-form Deformation of Solid Geometric Models,” Computer Graphics: Proceedings of SIGGRAPH 86, vol. 20, no. 4, pp. 151-159 (August 1986), which is incorporated herein by reference. A further description is found in U.S. Pat. No. 4,821,214 issued to Sederberg, T. W. on Apr. 11, 1989, which is also incorporated by reference herein.

There is a need for new ways to perform product design using CAD and CAE models in combination with FFD. Additionally, there is a need to enhance the FFD process to be more applicable to product design, reduce database requirement, and enable design modifications at a broad range of detail.

### BRIEF SUMMARY OF THE INVENTION

Embodiments of the present invention provide systems, methods, and computer readable media for performing product design and analysis. The new methods of product design use CAD and CAE models in combination with FFD. Additionally, the FFD process uses T-spline meshes to reduce database requirement, increase design flexibility and enable design modifications at a broad range of detail.

An embodiment of the invention includes a method for analyzing a simulation model. The method includes defining the simulation model utilizing a Computer-Aided Engineering (CAE) tool. A parametric volume including control points that form a mesh to at least partially bounding a design object of the simulation model is formed. The parametric volume includes at least one T-spline control point. The method also includes adjusting at least one control point on the parametric volume to deform a portion of the simulation model correlated to the control point. The deformed simulation model is simulated to develop a simulation result. The control point adjusting and the simulating may be repeated.

Another embodiment of the invention also includes a method for analyzing a simulation model. The method includes defining a simulation model utilizing a CAE tool. A parametric volume including control points that form a mesh to at least partially bounding a design object of the simulation model is formed. The parametric volume includes at least one T-spline control point. The method also includes repeatedly performing an analysis loop until a design objective is achieved. The analysis loop includes adjusting a control point on the parametric volume to deform a portion of the simulation model correlated to the control point, simulating the deformed simulation model to develop a simulation result, determining if the simulation results meet the design objective, and adding at least one additional control point to the parametric volume.

Another embodiment of the invention includes a computing system. The computing system includes a display, memory, and at least one processor coupled to the display and memory. The computing system is configured to define a parametric volume at least partially bounding a Computer-Aided Engineering (CAE) model representing a design object. The parametric volume includes at least one T-junction. Control points are defined on the parametric volume. The computing system also determines a deformation of the CAE model responsive to an adjustment of the control points and performs a simulation of the CAE model to develop a simulation result. The computing system also repeats the acts of determining a deformation of the CAE model and performing the simulation.

Yet another embodiment of the invention includes a computer readable media including computer executable instructions to be executed on a processor. When executing the computer instruction, the processor defines a simulation model and forms a T-spline control mesh at least partially bounding a design object of the simulation model. The T-spline control mesh includes at least one T-junction. The processor also adjusts at least one control point on the control mesh to deform a portion of the simulation model substantially near the control point and simulates the deformed simulation model to develop a simulation result. The processor also determines if the simulation results meet a design objective and repeats the control point adjusting and the simulating if the design objective is not achieved.

### BRIEF DESCRIPTION OF THE SEVERAL VIEWS OF THE DRAWINGS

In the drawings, which illustrate embodiments of the invention:

FIG. 1 is a flow chart illustrating a conventional product design methodology;

FIG. 2 illustrates a FFD distortion of a computer graphics shape;

FIG. 3 illustrates a Non-Uniform Rational B-Spline (NURBS) curve;

FIG. 4 illustrates a control mesh for a NURBS surface in two-dimensions;

FIG. 5 illustrates a T-spline control mesh for a surface in two-dimensions;

FIG. 6 illustrates a T-spline control mesh for a three-dimensional volume;

FIG. 7 is a simplified flow chart illustrating a product design process according to one or more embodiments of the present invention;

FIG. 8 is a Graphical User Interface GUI window illustrating a CAE model and a T-spline control mesh;

FIG. 9 is a GUI window illustrating the CAE model and T-spline control mesh of FIG. 8 with a control point deforming a control surface;

FIG. 10 illustrates a CAE model and T-spline control mesh;

FIG. 11 illustrates the CAE model and T-spline control mesh of FIG. 10 with a control point moved to deform the underlying CAE model;

FIGS. 12A-12F illustrate a process of defining a T-spline control mesh around a CAE model and deforming the CAE model; and

FIG. 13 is a simplified block diagram of a computing system useful for performing embodiments of the present invention.

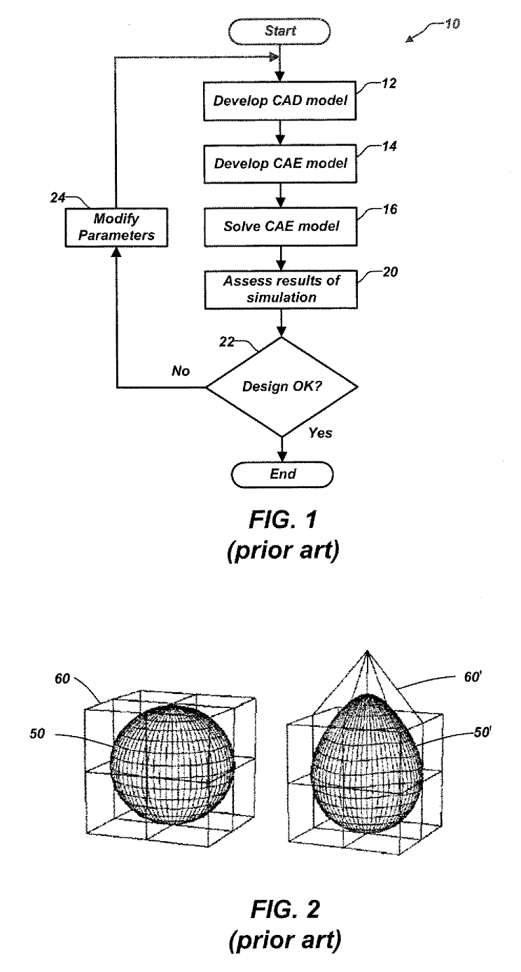

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those of ordinary skill in the art to practice the invention. It should be understood, however, that the detailed description and the specific examples, while indicating examples of embodiments of the invention, are given by way of illustration only and not by way of limitation. From this disclosure, various substitutions, modifications, additions rearrangements, or combinations thereof within the scope of the present invention may be made and will become apparent to those skilled in the art.

Software processes and analysis methods illustrated herein are intended to illustrate representative processes that may be performed by a general purpose or special purpose processing system. Unless specified otherwise, the order in which the process acts are described is not intended to be construed as a limitation, and acts described as occurring sequentially may occur in a different sequence, or in one or more parallel process streams. It will be appreciated by those of ordinary skill in the art that many steps and processes may occur in addition to those outlined in the flow charts. Furthermore, the processes may be implemented in any suitable hardware, software, firmware, or combinations thereof.

When executed as firmware or software, the instructions for performing the processes may be stored on a computer-readable medium. A computer-readable medium includes, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory.

By way of non-limiting example, computing instructions for performing the processes may be performed on a processing system (not shown). In the processing system, the computing instructions may be stored on operational storage, transferred to a memory for execution, and executed by one or more processors. The one or more processors, when executing computing instructions configured for performing the processes, constitutes structure for performing the processes. In addition, some or all portions of the processes may be performed by hardware specifically configured for carrying out the processes.

Embodiments of the present invention provide systems, methods, and computer readable media for performing product design and analysis. The new methods of product design use CAD and CAE models in combination with FFD. Additionally, the FFD process uses T-spline meshes to reduce database requirement, increase design flexibility and enable design modifications at a broad range of detail.

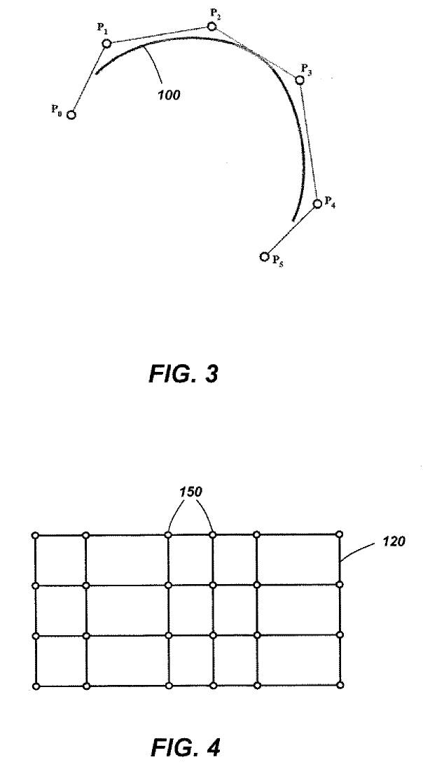

FIG. 3 illustrates a free-form Non-Uniform Rational B-Spline (NURBS) curve 100. A NURBS curve 100 is a parametric curve, meaning that the points along the curve smoothly change as the parameters of the curve change. The NURBS curve 100 can be described and visually represented by control point (P0-P5) around the NURBS curve 100. The NURBS curve 100 is formed by interpolating the position of the curve's control points as the parameters change. Additional control points can be added to create finer detail and sharper curves. NURBS curves 100 are particularly useful to designers because they provide continuity of the curve and local control that only affects the curve near the control point and its neighbors. In general, NURBS curves 100 may have multiple degrees. A cubic NURBS curve 100 can be decomposed into multiple adjacent cubic Bezier curves. The parameter values at which two adjacent Bezier curves meet are called knot values (or simply knots). Thus, a NURBS curve 100 is described by a series of control points and a sequence of knot values. A NURBS curve 100 exhibits local control. In other words, a control point strongly influences the closest Bezier curve, weakly influence neighboring Bezier curves and has little or no influence on more distant Bezier curves.

FIG. 4 illustrates a control mesh 120 for a NURBS surface in two-dimensions. A NURBS surface 120 is similar to a NURBS curve but in two dimensions. The control points 150, and knot values, define a resultant NURBS surface (not shown). The knot values are defined for two-dimensional space. As with a NURBS curve, a bi-cubic NURBS surface exhibits local control such that a given control point 150 strongly influences the NURBS surface closest to the control point and more weekly influences the NURBS surface moving away from the control point.

A control mesh 120 forms a rectangular grid with control points 150 at the intersections of the grids. Thus, to add a new control point, a new line must be added in each direction, along with control points at each intersection of the new line. As a result, many of the control points are of limited use, or serve no purpose except to satisfy the rectangular grid topology.

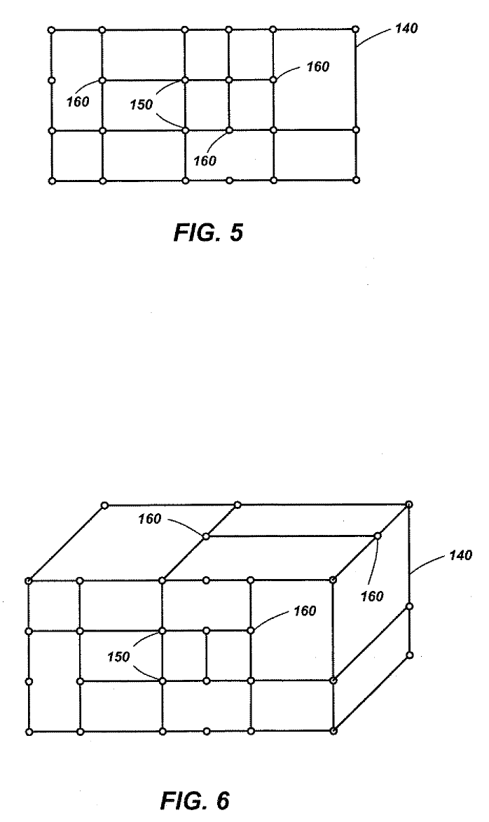

FIG. 5 illustrates a T-spline control mesh 140 (also referred to as a T-mesh) for a surface in two-dimensions. One difference between a T-mesh 140 and a NURBS control mesh 120 (FIG. 4) is that a T-mesh 140 allows a row of control points to terminate. Thus, a row may include many points or a single point. As a result, in a T-mesh 140 the control points may include cross-points 150 and T-points 160. With a T-mesh 140, conventional NURBS control points (i.e., cross-points 150) that may not be useful in defining or deforming the underlying surface may be removed to simplify the T-mesh 140. Conversely, new control points can be added as T-points 160 without having to add corresponding cross-points 150 at every intersection along a given line.

FIG. 6 illustrates a T-spline control mesh for a three-dimensional volume. As with the two-dimensional surface, a volume T-mesh 140 may include both cross-points 150 and T-points 160 as control points for the three-dimensional T-spline control mesh 140. In embodiments of the present invention, T-spline control meshes 140 may be applied to an underlying geometric shape or CAE model of the geometric shape to carry out Free-Form Deformation (FFD) of the underlying CAE model.

Conventional FFD has several shortcomings. One problem is that frequently, certain elements of the design may not be changed while other features of the design are being modified. In order to isolate parts of the design from the deformation, control points must be inserted into the CAE model. Since the control points of a conventional FFD are required to be topologically arranged in a lattice, the addition of control points causes entire planes of control points to be inserted. This produces a significant proliferation of control points. These control points are, therefore, frequently added in locations where they are not desired and serve no purpose other than to satisfy topological requirements.

Embodiments of the present invention overcome many problems of conventional product design by enabling FFD of a CAE model, rather than the CAD model. In addition, the FFD is performed using T-spline control meshes 140 to create a smaller database of control points that are easier to manipulate and enhance for fine control of the CAE model.

With deformation of the CAE model, CAD model modification and re-creation of the simulation model are removed from the design improvement cycle. If the accuracy of the CAE model is maintained, the product design cycle using simulation models can proceed quickly and can easily be automated.

In addition, T-Splines overcome many of the shortcomings of conventional FFD. T-Splines are not constrained by “superfluous” control points lying in a rectangular grid. T-Splines are also locally refineable. Therefore, the control points can be inserted into the control grid without propagating an entire plane of control points. Thus, the CAE model may be embedded in a parametric volume formed as a T-spline control mesh 140. Points on the CAE model are embedded by calculating their parametric coordinates inside that parametric space. The shape of the parametric space may then be changed by moving and modifying control points. As the parametric shape is changed, the mapping from parametric space to Cartesian space is changed so that the CAE model is deformed in a corresponding relationship with the parametric space. In other words, as the shape of the T-Spline volume is changed, the embedded CAE model is deformed in an analogous manner. For a cubic T-Spline, C¹ continuity is ensured so that the accuracy of the deformed elements of the CAE model is maintained.

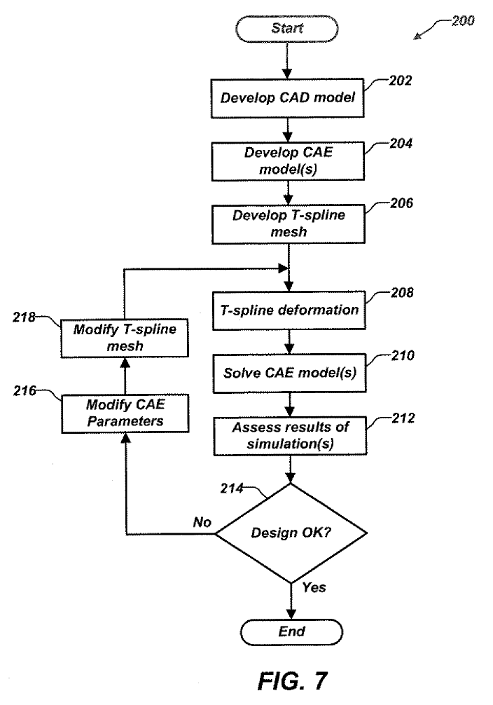

FIG. 7 is a simplified flow chart illustrating a product design process 200 according to one or more embodiments of the present invention. A CAD model is created in operation block 202. Of course, other kinds of models may be used in embodiments of the present invention. By way of non-limiting example, a model also may be developed from scanning an object with a laser, Computerized Axial Tomography (CAT) scans (sometimes called CT scans), or electromagnetic response maps.

One or more digital simulation models (also known as a Computer Aided Engineering (CAE) models are created from the CAD model (or other suitable model) in operation block 204. As non-limiting examples, the CAE model may be a Finite Element Analysis (FEA) model or a Computational Fluid Dynamics (CFD) model. As other non-limiting examples, the CAE model may be aero-acoustic models, electromagnetic field models, optical analysis models, and radar cross section models.

A T-spline control mesh is formed around all or portions of the CAE model in operation block 206. In operation block 208, one or more control points on the T-mesh are moved to deform the underlying CAE model in a manner that may produce behavior of the model targeted to meet various design objectives.

In operation block 210, the deformed CAE model is simulated (i.e., solved) to predict certain behaviors or performance aspects of the design. The performance of the design may be assessed in operation block 212 to determine if the design objectives have been achieved.

Decision block 214 indicates a decision of whether the design meets the design objectives. If the design is acceptable, the design process may terminate. If, however, the design needs more refinement, operation block 216 may modify design parameters of the CAE model. In addition, operation block 218 may modify parameters of the T-mesh. The T-mesh may be modified by removing control points or adding control points to refine how the CAE model will deform with movement of control points. The T-mesh may also be modified to encompass additional portions of the underlying CAE model. With potential changes to the CAE model and the T-mesh, the design loop begins again at operation block 208 with new T-mesh deformations 208, CAE model simulations 210, and assessment of the simulation results 212. The design loop may continue until the design objectives have been met.

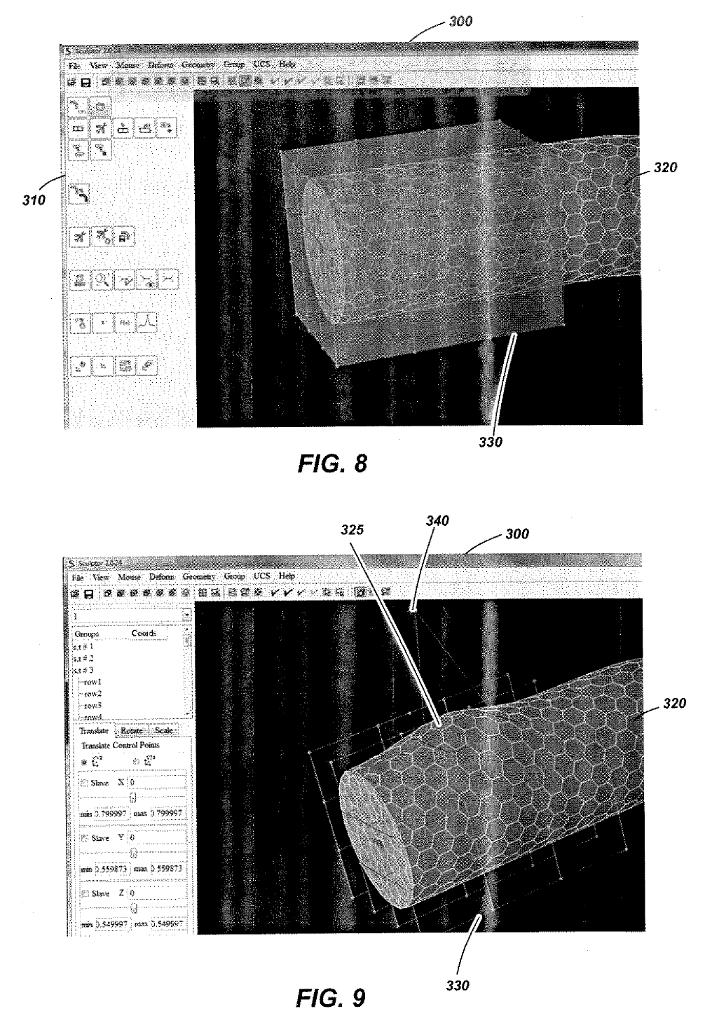

FIG. 8 is a Graphical User Interface (GUI) window 300 illustrating a CAE model 320 and a T-spline control mesh 330. As a non-limiting example, the CAE model 320 may be configured as a mesh of hexagons or other polyhedrons suitable for, as a non-limiting example, performing computational fluid dynamics analysis in and around the CAE model 320.

A variety of tools 310 are shown in the GUI for controlling operations, such as, for example, rotating and translating views, building and modifying the T-mesh, deforming the T-mesh, controlling simulations, and performing optimizations.

FIG. 9 is a GUI window 300 illustrating the CAE model 320 and T-spline control mesh 330 with a moved control point 340. The moved control points cause a deformation 325 of portions of the underlying CAE model 320.

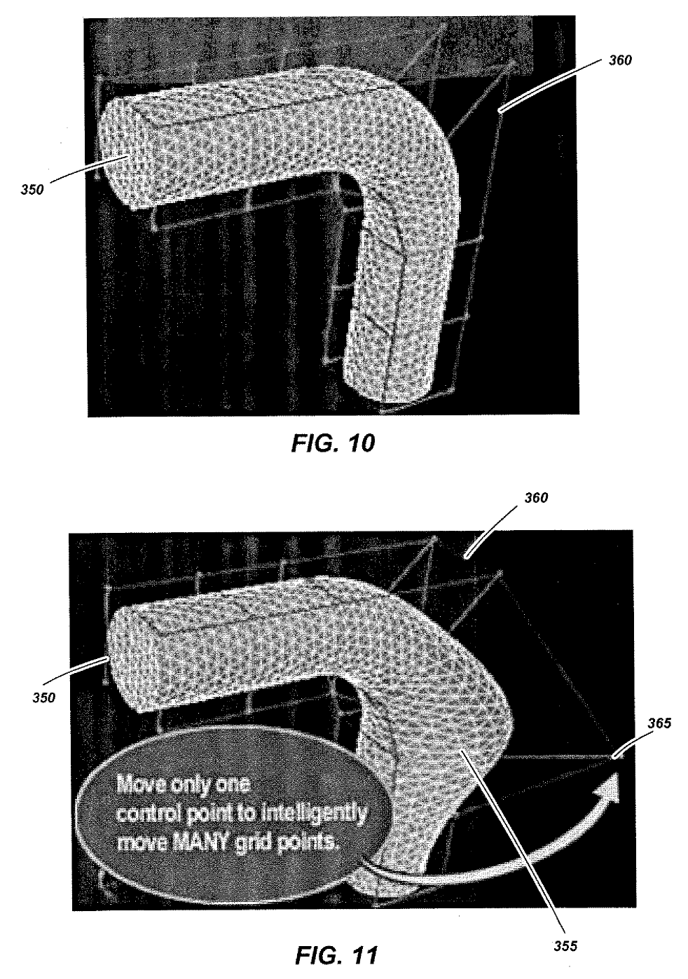

FIG. 10 illustrates a CAE model of an elbow 350 in a pipe and a corresponding T-spline control mesh 360 defined around the elbow 350. FIG. 11 also illustrates the elbow 350 and T-spline control mesh 360. In FIG. 11, a control point 365 has been moved and the resulting deformation 355 of the elbow 350 can be seen as a movement of a large number of points on the underlying CAE model of the elbow 350.

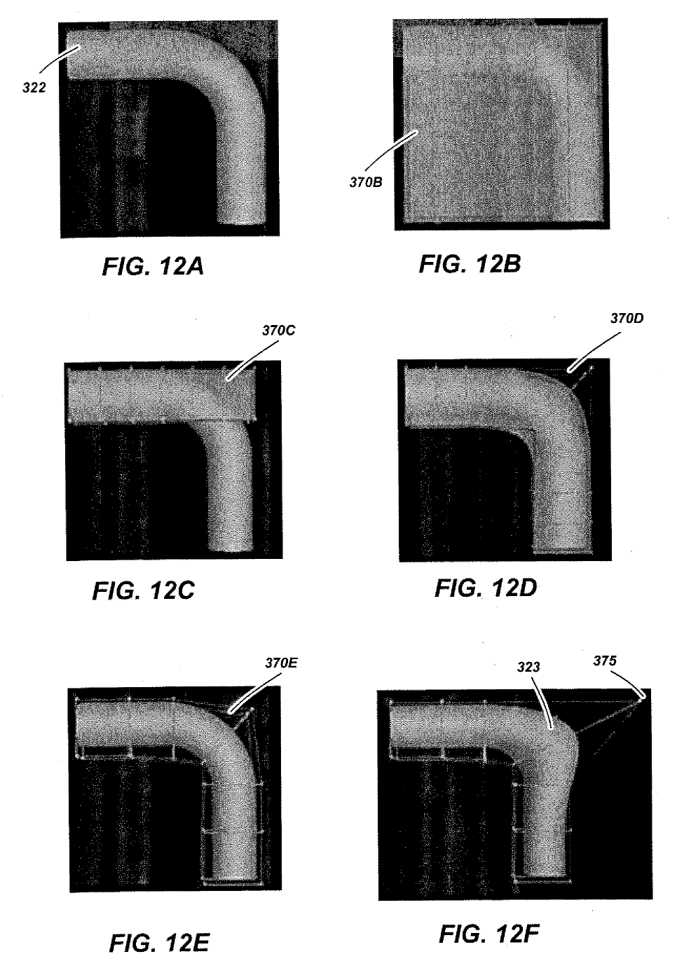

FIGS. 12A-12F illustrate a process of defining a T-spline control mesh around a CAE model and deforming the CAE model. FIG. 12A illustrates the pipe elbow 322 but with the CAE face edges concealed, leaving only a smooth surface representing the pipe elbow 322. FIG. 12B illustrates a first control mesh 370B as a bounding volume of vertical planes encompassing the pipe elbow. FIG. 12C illustrates a modification of the control mesh 370C by moving the bottom plane of the control mesh up so the control mesh encompasses the horizontal portion of the elbow. FIG. 12D illustrates a modification of the control mesh 370D to encompass the bend and vertical portion of the elbow.

After the control mesh is created, it may be modified to tightly encapsulate the underlying grid. The closer a control mesh conforms to the grid surface of the CAE model, the more responsive the grid is to the movements of the control points. In addition, non-useful control points may be eliminated and additional control points may be added to enable more precise control of deformations. FIG. 12E illustrates a modification of the control mesh 370E to more closely enclose the bend in the elbow. Finally, FIG. 12F shows a modified control point 375 and corresponding deformation 323 of the pipe elbow.

Those of ordinary skill in the art will recognize that while the volumes in FIGS. 10, 11, and 12A-12F may not directly illustrate T-points, T-points may be present and manipulated in the same manner as discussed with respect to these drawings.

In addition to adding and removing control points as either T-points or cross-points, points may be lumped together in groups to provide higher order control over the control points. When a group is manipulated, all the points in the group are affected according to a relationship that may defined by tools in the GUI window. As a non-limiting example, when a T-mesh volume is created, the points in each coordinate plane may be automatically lumped into individual groups. This plane grouping enables all the plane's points to move together simply by moving the plane.

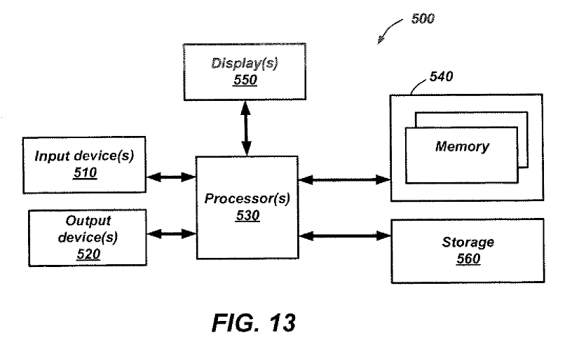

FIG. 13 is a simplified system block diagram of a computing system useful for performing embodiments of the present invention. As shown in FIG. 13, a computing system 500, may include at least one input device 510, at least one output device 520, at least one processor 530, memory 540, a display 550, and at least one storage device 560.

The memory 540 and storage devices 560 are configured for holding information including firmware or software including instructions for execution by the processor 530. The display may be used to display a GUI including depictions of CAD models, CAE models, T-meshes, and tools for manipulating and simulating the models and meshes.

The input devices and output devices may include a keyboard, a mouse, a joystick, a haptic device, communication devices, and other suitable devices for controlling operation of the computing system.

Although the present invention has been described with reference to particular embodiments, the present invention is not limited to these described embodiments. Rather, the present invention is limited only by the appended claims, which include within their scope all equivalent devices or methods that operate according to the principles of the present invention as described.

What is claimed is:

1. A method for analyzing a simulation model, comprising:
defining a simulation model utilizing a Computer-Aided Engineering (CAE) tool;
forming a parametric volume comprising a plurality of control points forming a mesh at least partially bounding a design object of the simulation model, wherein the parametric volume comprises at least one T-spline control point;
adjusting at least one control point on the parametric volume to deform at least a portion of the simulation model correlated to the at least one control point;
simulating the deformed simulation model to develop a simulation result;
repeating the adjusting and the simulating to modify the simulation result.

2. The method of claim 1, wherein the simulation model is selected from the group consisting of a finite element model and a computational fluid dynamics model.

3. The method of claim 1, further comprising refining the parametric volume by adding additional control points to the parametric volume wherein the additional control points are selected from the group consisting of T-points and cross-points.

4. The method of claim 1, further comprising refining the parametric volume by removing control points from the parametric volume wherein the removed control points are selected from the group consisting of T-points and cross-points.

5. The method of claim 1, further comprising refining the parametric volume by grouping two or more control points to move together.

6. The method of claim 1, further comprising:
analyzing the simulation results relative to at least one design objective; and
repeating the adjusting and the simulating until the at least one design objective has been achieved.

7. The method of claim 6, wherein the process of analyzing the simulation results and repeating the adjusting and the simulating until the at least one design objective has been achieved is automated by a process of automatically iterating through a range of control point adjustments.

8. The method of claim 1, wherein splines are used for interpolation, smoothing, or combination thereof of either one-dimensional or multi-dimensional portions of the simulation model.

9. The method of claim 1, wherein defining a simulation model further comprises deriving the simulation model from a Computer-Aided Design (CAD) model.

10. A method for analyzing a simulation model, comprising:
defining a simulation model utilizing a Computer-Aided Engineering (CAE) tool;
forming a parametric volume comprising a plurality of control points forming a mesh to at least partially bounding a design object of the simulation model, wherein the parametric volume comprises at least one T-spline control point;
repeatedly performing an analysis loop until a design objective is achieved, comprising:
adjusting at least one control point on the parametric volume to deform at least a portion of the simulation model correlated to the at least one control point;
simulating the deformed simulation model to develop a simulation result;
determining if the simulation results meet the at least one design objective; and
adding at least one additional control point to the parametric volume.

11. The method of claim 10, wherein the simulation model is selected from the group consisting of a finite element model and a computational fluid dynamics model.

12. The method of claim 10, wherein defining a simulation model further comprises deriving the simulation model from a Computer-Aided Design (CAD) model.

13. A computing system, comprising:
a display;
a memory;
at least one processor operably coupled to the display and memory, wherein the computing system is configured for:
defining a parametric volume at least partially bounding a Computer-Aided Engineering (CAE) model representing a design object, wherein the parametric volume comprises at least one T-junction;
defining at least one control point on the parametric volume;
determining a deformation of the CAE model responsive to an adjustment of the at least one control point;
performing a simulation of the CAE model to develop a simulation result; and
repeating the determining and the performing to modify the simulation result.

14. The computing system of claim 13, wherein the simulation model is selected from the group consisting of a finite element model and a computational fluid dynamics model.

15. The computing system of claim 13, wherein the computing system is further configured for refining the parametric volume by adding additional control points to the parametric volume wherein the additional control points are selected from the group consisting of T-points and cross-points.

16. The computing system of claim 13, wherein the computing system is further configured for refining the parametric volume by removing control points from the parametric volume wherein the removed control points are selected from the group consisting of T-points and cross-points.

17. The computing system of claim 13, wherein the computing system is further configured for:
analyzing the simulation results relative to at least one design objective; and
repeating the determining and the performing until the at least one design objective has been achieved.

18. The computing system of claim 13, wherein splines are used for interpolation, smoothing, or combination thereof of either one-dimensional or multi-dimensional portions of the simulation model.

19. A computer readable media including computer executable instructions, which when executed on a processor perform acts, comprising:
defining a simulation model;
forming a T-spline control mesh at least partially bounding a design object of the simulation model, wherein the T-spline control mesh includes at least one T-junction;
adjusting at least one control point on the control mesh to deform at least a portion of the simulation model substantially near the at least one control point;
simulating the simulation model to develop a simulation result;
determining if the simulation results meet at least one design objective; and
repeating the adjusting and the simulating to modify the simulation result if the at least one design objective is not achieved.

20. The computer readable media of claim 19, wherein the simulation model is selected from the group consisting of an aero-acoustic model, an electromagnetic field model, an optical analysis model, and a radar cross section model.

21. The computer readable media of claim 19, further comprising computer executable instructions for refining the parametric volume by adding additional control points to the parametric volume or removing control points from the parametric volume, wherein the control points are selected from the group consisting of T-points and cross-points.

22. The computer readable media of claim 19, wherein splines are used for interpolation, smoothing, or combination thereof of either one-dimensional or multi-dimensional portions of the simulation model.
